(19) United States
(12) Patent Application Publication
(10) Pub. No.: US 2018/0131767 A1
(43) Pub. Date: May 10, 2018

(54) AUTONOMOUS VEHICLE MANAGEMENT

(71) Applicant: Ford Global Technologies, LLC, Dearborn, MI (US)

(72) Inventors: Dalya Kozman, Allen Park, MI (US); Youhanna Massoud, Allen Park, MI (US)

(73) Assignee: Ford Global Technologies, LLC, Dearborn, MI (US)

(21) Appl. No.: 15/344,700

(22) Filed: Nov. 7, 2016

(51) Int. Cl. H04L 29/08; H04L 29/06; H04W 64/00

(52) U.S. Cl. CPC H04L 67/12; H04L 67/42; H04L 67/02; H04W 84/12; H04L 67/303; H04L 67/306; H04W 64/006

(57) ABSTRACT

A computer is programmed to store start and end locations for a vehicle route, and receive input, including a user identifier, when the vehicle is at the start location. The computer is further programmed to navigate the vehicle from the start location to a third location distinct from the start and end locations, and receive, when the vehicle is at the third location, input including the user identifier and data indicating that a user has left the vehicle. The computer then calculates an adjusted ride cost, based on a difference in the third location and the end location.

### BACKGROUND

An autonomous vehicle operates according to instructions from a computer, and without intervention of a user. Thus, the vehicle may operate, e.g., travel along a planned route, with or without occupants. An autonomous vehicle can be shared among multiple users, e.g., as part of a vehicle ride-sharing fleet such as a public transport system. However, the autonomous vehicle, e.g., when operating as a ride-sharing fleet, may lack an operator to manage vehicle use.

### BRIEF DESCRIPTION OF THE DRAWINGS

FIG. 1 is a block diagram of an exemplary system for monitoring an operation of an autonomous vehicle.

FIG. 2 is a flowchart of an exemplary process for creating a travel plan for the autonomous vehicle of FIG. 1.

FIG. 3 is a flowchart of an exemplary process for managing a travel plan of FIG. 2.

### DETAILED DESCRIPTION

### Introduction

An autonomous vehicle controller, e.g., a vehicle 100 computer 110, can store start and end locations for a vehicle 100 route. The start and end locations may be stored prior to one or more users entering the vehicle 100, or may be provided by the user(s) upon entering the vehicle 100. The vehicle 100 computer 110 can further receive input including a user identifier when the vehicle 100 is at the first location. Known authentication techniques such as “bar code”, Quick Response (QR) code, biometric information, etc., may be used for the user identifier. The vehicle 100 computer 110 then navigates the vehicle 100 from the start location to a third location distinct from the start and end locations. When the vehicle 100 reaches the third location, the vehicle 100 computer 110 receives input including the user identifier and data indicating that a user has left the vehicle 100, e.g., using vehicle 100 sensor 130 data. The vehicle 100 computer 110 then calculates an adjusted ride cost based at least on a difference in the third location and the end location.

### System Elements

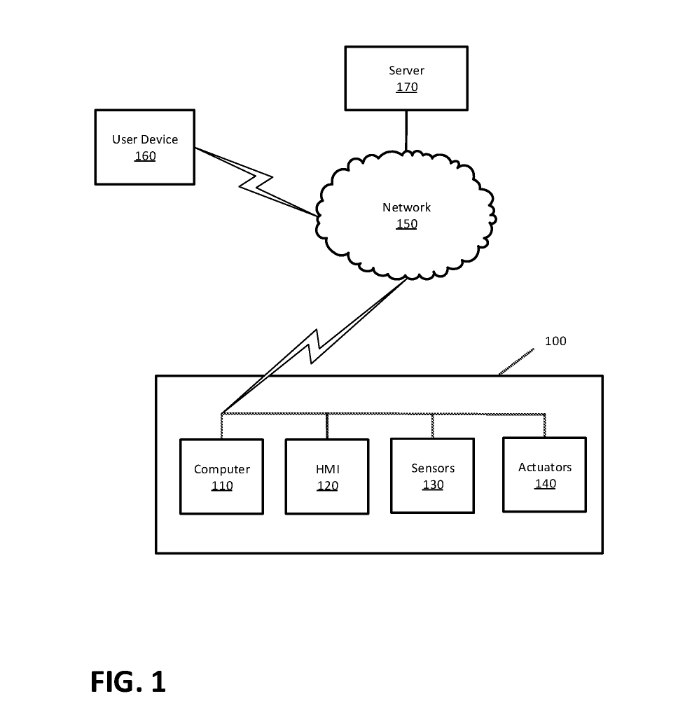

FIG. 1 illustrates an example vehicle 100 including a computer 110 that is programmed to store start and end locations for a vehicle route, and to receive input, including a user identifier, when the vehicle 100 is at the first location. The computer 110 is further programmed to navigate the vehicle 100 from the start location to a third location distinct from the start and end locations. The computer 110 is programmed to receive input, including the user identifier, and data indicating that a user has left the vehicle, when the vehicle is at the third location. The computer 110 then calculates an adjusted ride cost based on a difference in the third location and the end location.

The vehicle 100 may be powered in variety of known ways, e.g., with an electric motor and/or internal combustion engine. The vehicle 100 includes the computer 110, sensors 130, a human machine interface (HMI) 120, actuators 140, and other components discussed herein below.

The computer 110 includes a processor and a memory such as are known. The memory includes one or more forms of computer-readable media, and stores instructions executable by the computer 110 for performing various operations, including as disclosed herein.

The computer 110 may operate the vehicle 100 in an autonomous or semi-autonomous mode. For purposes of this disclosure, an autonomous mode is defined as one in which each of vehicle 100 propulsion, braking, and steering are controlled by the computer 110; in a semi-autonomous mode the computer 110 controls one or two of vehicle 100 propulsion, braking, and steering.

The computer 110 may include programming to operate one or more of vehicle brakes, propulsion (e.g., control of acceleration in the vehicle by controlling one or more of an internal combustion engine, electric motor, hybrid engine, etc.), steering, climate control, interior and/or exterior lights, etc., as well as to determine whether and when the computer 110, as opposed to a human operator, is to control such operations.

The computer 110 may include or be communicatively coupled to, e.g., via a vehicle communications bus as described further below, more than one other computing devices, e.g., controllers or the like included in the vehicle for monitoring and/or controlling various vehicle components, e.g., controllers can include electronic control units (ECUs) such as a powertrain controller, a brake controller, a steering controller, etc. The computer 110 is generally arranged for communications on a vehicle communication network such as a controller area network (CAN) or the like.

Via the vehicle 100 network, the computer 110 may transmit messages to various devices in the vehicle 100 and/or receive messages from the various devices, e.g., controllers, actuators, sensors, etc., including sensors 130. Alternatively or additionally, in cases where the computer 110 actually comprises multiple devices, the vehicle communication network may be used for communications between devices represented as the computer 110 in this disclosure. Further, as mentioned below, various controllers and/or sensors 130 may provide data to the computer 110 via the vehicle communication network.

In addition, the computer 110 may be configured for communicating through a vehicle-to-infrastructure (V-to-I) interface with a server 170 via a network 150. The network 150 represents one or more mechanisms by which the user devices 160, the computer 110, and the server 170 may communicate with each other, and may be one or more of various wired or wireless communication mechanisms, including any desired combination of wired (e.g., cable and fiber) and/or wireless (e.g., cellular, wireless, satellite, microwave and radio frequency) communication mechanisms and any desired network topology (or topologies when multiple communication mechanisms are utilized). Exemplary communication networks include wireless communication networks (e.g., using one or more of cellular, Bluetooth, IEEE 802.11, etc.), dedicated short range communications (DSRC), local area networks (LAN) and/or wide area networks (WAN), including the Internet, providing data communication services.

As already mentioned, generally included in instructions stored in the memory and executed by the computer 110 is programming for operating one or more vehicle 100 components, e.g., braking, steering, propulsion, etc., without intervention of a human operator. Using data received in the computer 110, e.g., the sensor data from the sensors 130, the server 170, etc., the computer 110 may make various determinations and/or control various vehicle components and/or operations without a driver to operate the vehicle. For example, the computer 110 may include programming to regulate vehicle operational behaviors such as speed, acceleration, deceleration, steering, etc., as well as tactical behaviors such as a distance between vehicles and/or amount of time between vehicles, lane-change minimum gap between vehicles, left-turn-across-path minimum, time-to-arrival at a particular location, intersection (without signal) minimum time-to-arrival to cross the intersection, etc.

Controllers, as that term is used herein, are devices with memories and processors that typically are programmed to control a specific vehicle subsystem. Examples include a powertrain controller, a brake controller, and a steering controller. A controller may be an electronic control unit (ECU) such as is known, possibly including additional programming as described herein. The controllers may communicatively be connected to and receive instructions from the computer 110 to actuate subsystem vehicle component, e.g., braking, steering, powertrain, etc., according to the instructions. For example, the brake controller may receive instructions from the computer 110 to operate the brakes of the vehicle.

Sensors 130 may include a variety of devices known to provide data via the vehicle communications bus. For example, the sensors 130 may include one or more camera sensors 130, scanner sensors 130 to read encoded images such as bar codes, seat occupancy sensors 130, etc., the sensors 130 being disposed in the vehicle 100 providing data encompassing at least some of the vehicle interior and/or exterior. The data may be received by the computer 110 through a suitable interface such as in known. The computer 110 may authenticate users based on the received data.

Further, the sensors 130 may include microphones disposed in the vehicle, e.g., the interior or a trunk, providing audio data. For example, the computer 110 may communicate with a user to, e.g., identify the user of the vehicle 100, e.g., using voice recognition techniques.

The sensors 130 may include a GPS (global positioning system) device. The GPS sensor may transmit a current geographical coordinate of the vehicle 100 via the vehicle communication network, e.g., vehicle 100 bus.

The actuators 140 are implemented via circuits, chips, or other electronic components that can actuate various vehicle subsystems in accordance with appropriate control signals as is known. The actuators 140, therefore, may be used to control braking, acceleration, and steering of the host vehicle 100. Additionally, the actuators 140 may control access to the vehicle 100, e.g., release/lock doors. The control signals used to control the actuators 140 may be generated by the computer 110, a control unit located in the vehicle 100, e.g., the brake controller, etc.

The human-machine interface (HMI) 120 can include a touch screen, an interactive voice response (IVR) system, and/or other input/output mechanisms such as are known, and can receive input data from a user and/or outputs data to the user. For example, the HMI 120 may have a soft key or a push button to initiate movement and/or to request a stop of the vehicle 100.

A user device 160 may communicate with the computer 110 via the network 150. The user device 160 may be a smartphone or wearable computer communicating via the network 150. The user device 160 may include input mechanisms to, e.g., input a PIN code, initiate a movement of the vehicle, etc., and output mechanisms to, e.g., output a visual and/or audio information to the user. The computer 110 may determine a location of the user device 160 via e.g., a GPS device or a short range communication interface included in the user device 160.

The server 170 is a remote computer or computers communicating with the computer 110 via the network 150, e.g., Long-Term Evolution (LTE).

### Processes

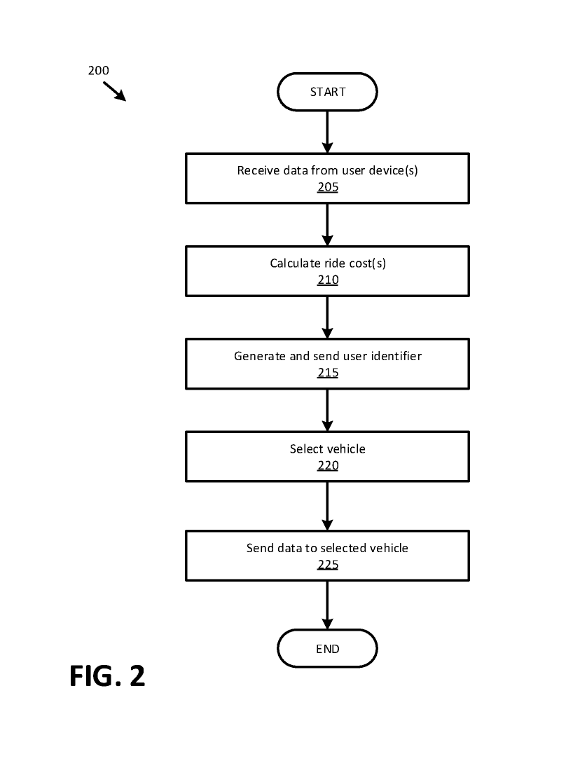

FIG. 2 illustrates a flowchart of an exemplary process 200 for generating a travel plan for the vehicle 100. For example, the server 170 may be programmed according to the process 200.

The process 200 begins in a block 205, in which the server 170 receives data from a user device 160. The received data may include a start location, an end location, and a number of users planning to travel with a vehicle 100. The start and/or end locations may be GPS coordinates, points of interest such as historic landmarks, and/or addresses, e.g., including a street name and number. Additionally, the received data may include other information such as time of departure, preferred route, current location of the user device 160, etc.

Next, in a block 210, the server 170 calculates a ride cost for the user(s) based on the received data from the user device(s) 160. For example, the server 170 may identify a route from the start location to the end location and calculate the ride cost based on the identified route and the number of users. Additionally, the server 170 may calculate a ride cost based on user data, i.e., data associated with a user may indicate an attribute, e.g., age, and/or a weight (e.g., a discount percentage) for a specific user, e.g., applying a discount for a child user.

Next, in a block 215, the server 170 generates a travel plan including the start and end locations, the number of users, and identity of the users. The server 170 then generates user identifiers such as a bar code, a QR code, etc., for each of the users associated with user data including the start and end locations, and a status of a ride cost payment. The payment status may include data indicating whether an electronic payment transaction to pay for the ride has been completely carried out. The server 170 sends the generated user identifiers to the user device 160. Additionally or alternatively, the server 170 may associate the travel plan to a pre-existing user identifier, e.g., reusable badge, membership card, etc., rather than generating a new user identifier for each travel. In another example, the server 170 may update an already generated travel plan and generate an updated travel plan, e.g., a user added to or removed from a travel plan.

Next, in a block 220, the server 170 selects a vehicle 100 among multiple available vehicles 100 based on the travel plan generated at the block 215. In one example, the server 170 may select a vehicle 100 with an estimated time to arrive at the start location that is lower compared to estimated time to arrive of other available vehicles 100. In another example, the server 170 may select a vehicle 100 which was chosen by a user, e.g., based on input indicating a specific vehicle 100 or category of vehicle 100, such as license plate number, type of vehicle 100, etc., received from the user device 160. In another example, the server 170 may select a vehicle 100 which is selected for a second travel plan, when the second travel plan indicates that the start and end locations of the travel plan are on a route associated with the second travel plan. Additionally, the server 170 may verify whether the selected vehicle 100 has enough spaces available for the number of users. If not enough spaces available, the server 170 may send data to the user device 160 presenting other options such as waiting, splitting the users into multiple groups using different vehicles 100, etc.

Next, in a block 225, the server 170 sends data including the travel plan to the selected vehicle 100. For example, the server 170 may send the GPS coordinates of the start and end locations, and the number of users to the selected vehicle 100. Additionally, the server 170 may send user identifiers, e.g., bar code, QR code, etc., associated with the travel plan to the selected vehicle 100.

Following the block 225, the process 200 ends. Alternatively, although not shown in FIG. 2, if the server 170 continues operation, the process 200 can return to the block 205.

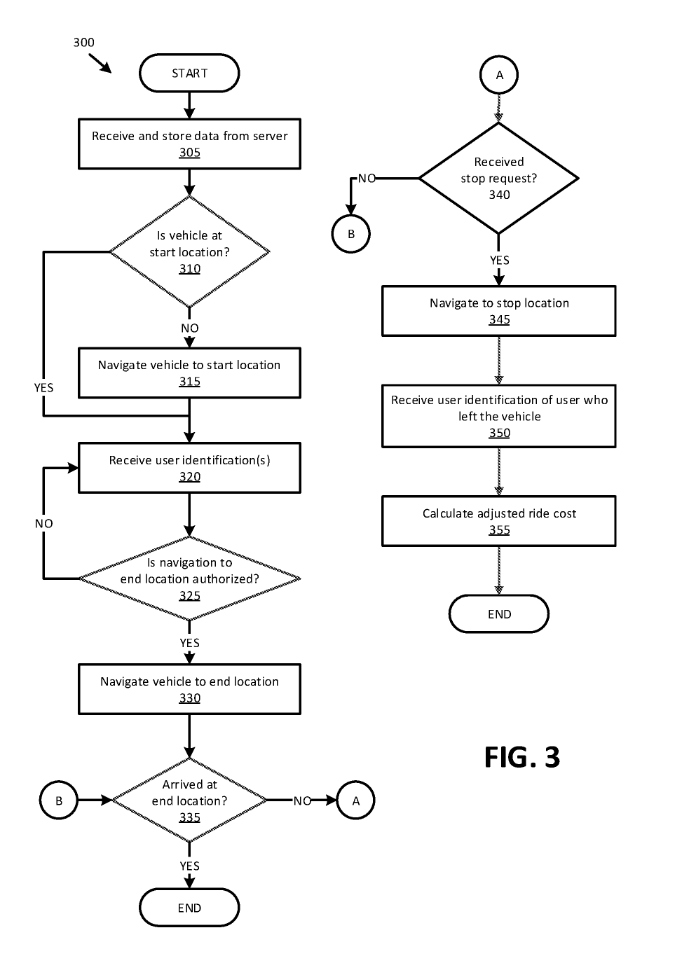

FIG. 3 is a flowchart of an exemplary process 300 for managing a travel plan of FIG. 2. For example, a vehicle 100 computer 110, selected according to the process 200 as discussed above, may be programmed according to the process 300.

The process 300 begins in a block 305, in which the vehicle 100 computer 110 receives data from the server 170 and stores the received data. The received data may include a start and end locations, and the number of users.

Next, in a decision block 310, the vehicle 100 computer determines whether the vehicle 100 is at the start location, e.g., based on data received from a vehicle 100 GPS sensor 130. If the vehicle 100 computer 110 determines that the vehicle 100 is at the start location, then the process 300 proceeds to a block 320; otherwise the process 300 proceeds to a block 315.

In the block 315, the vehicle 100 computer 110 navigates the vehicle 100 to the start location, i.e., navigates the vehicle from a vehicle 100 current location to the start location. For example, the vehicle 100 computer 110 navigates the vehicle 100 by actuating the vehicle 100 actuators 140 based on data received from the vehicle 100 sensors 130.

In the block 320, the vehicle 100 computer 110 receives user identifiers of users in the vehicle 100. For example, the computer 110 receives user identifiers data from a vehicle 100 scanner sensor 130, e.g. by scanning an encoded image such as QR code printed on paper or displayed on a user device 160 display.

Next, in a decision block 325, the computer 110 verifies whether a navigation to the end location is authorized. For example, the computer 110 verifies the authorization by verifying whether a number of users in the vehicle 100 matches a number of user identifiers, e.g., according to scanned encoded images, received by the computer 110. The computer 110 may identify the number of users in the vehicle 100 based on data received from a vehicle camera sensor 130, a vehicle seat occupancy sensor 130, and/or a user device 160. Additionally or alternatively, the computer 110 may verify the authorization by verifying a validity of each of the user identifiers, i.e., whether the received user identifier is associated with a valid travel plan. In one example, the validity status may indicate whether the user has paid for the travel from the start to the end location in advance. In another example, the validity status may indicate whether the user is at the start location included in the travel plan associated to the user identifier, e.g., the user scans the encoded image while the vehicle 100 is at the start location. In another example, the computer 110 verifies the validity of the user identifiers by sending the user identifiers data to the server 170 and receiving a validity status for each of the user identifiers from the server 170. If the computer 110 authorizes the navigation to the end location, then the process 300 proceeds to a block 330; otherwise the process 300 returns to the block 320 to receive further user identifiers.

Next, in the block 330, the computer 110 navigates the vehicle 100 to the end location by actuating the vehicle 100 actuators 140 based on data received from the vehicle 100 sensors 130.

Next, in a decision block 335, the computer 110 verifies whether the vehicle 100 arrived at the end location, e.g., based on the GPS coordinates of the end location and a current vehicle 100 coordinates received from the vehicle 100 GPS sensor 130. If the computer 110 determines that the vehicle 100 received at the end location, then the process 300 ends; otherwise the process 300 proceeds to a decision block 340.

In the decision block 340, the computer 110 determines whether to stop the vehicle 100 to allow the user to depart the vehicle 100, e.g., a vehicle 100 HMI 120 input is actuated by a user. Additionally or alternatively, a stop request may be received from a user device 160, the server 170, and/or a vehicle 100 audio sensor 130 detecting a user oral stop request using speech recognition techniques, such as are known. The stop request may include data specifying a stop location, e.g., an address. Alternatively, the stop request may include data indicating a request for stop as soon as possible. If the computer 110 receives a stop request, then the process 300 proceeds to a block 345; otherwise the process 300 returns to the decision block 335.

In the block 345, the computer 110 navigates the vehicle 100 to the stop location. For example, when a stop request includes a request to stop as soon as possible, then the computer 110 may calculate a third location, e.g., based on map data including parking restrictions and/or vehicle 100 sensor 130 data including parking space availability near current location of the vehicle 100. The computer 110 may navigate the vehicle 100 to the third location by actuating the vehicle 100 actuators 140 based on data received from the vehicle 100 sensors 130.

Next, in a block 350, the computer 110 receives data indicating that one or more users have left the vehicle 100, e.g., including user identifiers of the user(s) who have left the vehicle 100. For example, a user may scan an encoded image such as a QR code at a vehicle 100 scanner sensor 130 prior to exiting the vehicle 100. Additionally or alternatively, the computer 110 may receive data indicating the user(s) left the vehicle 100 from vehicle 100 camera sensor 130, vehicle 100 seat occupancy sensor 130, and/or a user device 160. For example, using known image processing techniques, the computer 110 may determine, based on data from a vehicle 100 camera sensor 130, that a user left the vehicle 100, e.g., by comparing image data received from the camera sensor 130 from a time before and a time after stopping at the third location. As another example, location data, e.g., GPS coordinates, received from a user device 160 GPS sensor may indicate that a user has left the vehicle 100, e.g., when location of the user device 160 differs from the vehicle 100 location. As another example, the computer 110 may receive data from vehicle 100 doors, e.g., opening and closing, indicating that one or more users may have left the vehicle.

Next, in a block 355, the computer 110 calculates an adjusted ride cost. Additionally, the computer 110 may provide data indicating the adjusted ride cost(s) to each of the user devices 160. As discussed above, the computer 110 may receive data indicating which user(s) left the vehicle 100 such as data including user device(s) 160 location and/or user identifiers of users which scanned encoded images prior to exiting the vehicle 100. As one example, the computer 110 may adjust the ride cost by determining a percentage of the travel route unused by the user(s) which left the vehicle 100 and initiate a partial refund of payment based on the adjusted ride cost. As another example, the computer 110 may adjust the ride cost based on a combination of time and distance of travel to the stop location. For example, driving the vehicle 100 through heavy traffic areas along a route from the start location to the stop location that is approximately half way between the start and end locations may take 80% of a total estimated time of travel. Thus, the computer 110 may be programmed to calculate an adjusted ride cost based on time and/or distance of travel to the stop location. For example, the computer 110 may adjust the ride cost by calculating an average of adjusted costs based on time and distance of travel, e.g., an adjusted rid cost of 65% as an average of 80% travel time and 50% travel distance. In another example, the computer 110 may select a maximum of time and distance of travel to calculate the adjusted ride costs, e.g., an adjusted ride cost of 80%, because 80% time of travel is greater than 50% distance of travel.

Following the block 355, the process 300 ends, or, although not shown in FIG. 3, if other users planed for the end location are still in the vehicle 100, the process 300 can proceed to the block 330.

Computing devices as discussed herein generally each include instructions executable by one or more computing devices such as those identified above, and for carrying out blocks or steps of processes described above. Computer-executable instructions may be compiled or interpreted from computer programs created using a variety of programming languages and/or technologies, including, without limitation, and either alone or in combination, Java™, C, C++, Visual Basic, Java Script, Perl, HTML, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media. A file in the computing device is generally a collection of data stored on a computer readable medium, such as a storage medium, a random access memory, etc.

A computer-readable medium includes any medium that participates in providing data (e.g., instructions), which may be read by a computer. Such a medium may take many forms, including, but not limited to, non-volatile media, volatile media, etc. Non-volatile media include, for example, optical or magnetic disks and other persistent memory. Volatile media include dynamic random access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH, an EEPROM, any other memory chip or cartridge, or any other medium from which a computer can read.

With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of systems and/or processes herein are provided for the purpose of illustrating certain embodiments, and should in no way be construed so as to limit the disclosed subject matter.

Accordingly, it is to be understood that the present disclosure, including the above description and the accompanying figures and below claims, is intended to be illustrative and not restrictive. Many embodiments and applications other than the examples provided would be apparent to those of skill in the art upon reading the above description. The scope of the invention should be determined, not with reference to the above description, but should instead be determined with reference to claims appended hereto and/or included in a non-provisional patent application based hereon, along with the full scope of equivalents to which such claims are entitled. It is anticipated and intended that future developments will occur in the arts discussed herein, and that the disclosed systems and methods will be incorporated into such future embodiments. In sum, it should be understood that the disclosed subject matter is capable of modification and variation.

What is claimed is:

1. A computer, comprising a processor and a memory, the memory storing instructions executable by the processor such that the computer is programmed to:
store start and end locations for a vehicle route;
receive input, including a user identifier, when the vehicle is at the start location;
navigate from the start location to a third location distinct from the start and end locations;
receive, when the vehicle is at the third location, input including the user identifier and data indicating that a user has left the vehicle; and
based on a difference in the third location and the end location, calculate an adjusted ride cost.

2. The computer of claim 1, further programmed to receive data indicating the user identifier from a user device and to provide the adjusted ride cost to the user device.

3. The computer of claim 1, wherein the user identifier is provided in an encoded image and the computer is further programmed to scan the encoded image.

4. The computer of claim 3, wherein the encoded image is stored in a user device.

5. The computer of claim 1, further programmed to receive a stop request including data indicating the third location.

6. The computer of claim 1, further programmed to receive the data indicating that the user has left the vehicle from at least one of a vehicle camera, a seat occupancy sensor, and a user device.

7. The computer of claim 1, wherein the computer is further programmed to calculate a ride cost based at least on the start and end locations.

8. The computer of claim 1, wherein the user identifier is associated with user data including the start and end locations, and a status of a ride cost payment.

9. A computer, comprising a processor and a memory, the memory storing instructions executable by the processor such that the computer is programmed to:
at a first location, receive first inputs including respective user identifiers from each of a plurality of user devices when a vehicle is at the first location;
verify that a number of user identifiers matches a number of users in the vehicle;
navigate the vehicle from the first location to a second location;
receive second input including one of the user identifiers;
receive data indicating that a user device associated with the user identifier in the second input has departed the vehicle; and
provide respective ride costs to each of the user devices based on the second location and the departed user device.

10. The computer of claim 9, wherein each of the user identifiers is provided in an encoded image and the computer is further programmed to scan the encoded image.

11. The computer of claim 9, further programmed to identify the number of users based on data received from at least one of a vehicle camera, a vehicle seat occupancy sensor, and a user device.

12. The computer of claim 9, further programmed to receive a stop request including data indicating the second location and navigate the vehicle from the first location to the second location based at least on the received stop request.

13. The computer of claim 9, further programmed to identify the number of users based on data received from at least one of a vehicle camera and a seat occupancy sensor.

14. The computer of claim 9, further programmed to receive data indicating the first location, the second location, and a number of users, and generate one or more user identifiers, wherein the number of users matches a number of the one or more user identifiers.

15. The computer of claim 14, further programmed to output the generated user identifiers to the plurality of user devices.

16. The computer of claim 9, further programmed to receive user data associated with the user identifiers from a second computer, and verify a validity of each of the user identifiers based on the received user data.

17. The computer of claim 16, wherein the computer is programmed to verify the validity of each of the user identifiers by verifying whether the user identifier is associated with a completed payment transaction.

18. The computer of claim 16, wherein the computer is programmed to verify the validity of each of the user identifiers by verifying whether a vehicle location matches a start location associated with the user identifier.

19. The computer of claim 9, wherein the computer is further programmed to calculate the respective ride costs based on a distance between the first and the second locations.

20. The computer of claim 9, wherein the computer is further programmed to calculate the respective ride costs based on a time of travel from the first location to the second location and an estimated time of travel from the first location to the second location.
